(19) United States
(12) Patent Application Publication
(10) Pub. No.: US 2026/0194842 A1
(43) Pub. Date: Jul. 9, 2026

(54) IMAGE FORMING APPARATUS, FOG MARGIN SETTING METHOD, AND NON-TRANSITORY COMPUTER-READABLE RECORDING MEDIUM STORING FOG MARGIN SETTING PROGRAM

(71) Applicant: Konica Minolta, Inc., Tokyo (JP)

(72) Inventor: Masanori KAWADA, Aichi (JP)

(21) Appl. No.: 19/429,166

(22) Filed: Dec. 22, 2025

(30) Foreign Application Priority Data
Jan. 7, 2025 (JP) 2025-002288

(51) Int. Cl. G03G 15/095; G03G 15/00; G03G 15/06

(52) U.S. Cl. CPC G03G 15/095; G03G 15/065; G03G 15/5058

(57) ABSTRACT

Provided is an image forming apparatus that includes: at least one hardware processor that controls an image former such that the image former forms a detection image with toner by setting a fog margin, which is a potential difference between a charging potential of a photoconductor and a developing potential of a developing apparatus, to a detection potential difference at a timing between a plurality of sheets during a print job; and a detector that detects a toner amount or a value related to the toner amount in the formed detection image. The at least one hardware processor sets, based on the detected toner amount or the detected value, the fog margin when a print image is formed.

### CROSS REFERENCE TO RELATED APPLICATIONS

The entire disclosure of Japanese Patent Application No. 2025-002288, filed on January 7, 2025, is incorporated herein by reference in its entirety.

### BACKGROUND

### Technological Field

The present invention relates to an image forming apparatus, a fog margin setting method, and a non-transitory computer-readable recording medium storing a fog margin setting program.

### Description of Related Art

In an electrophotographic image forming apparatus which is applied to various kinds of multifunction peripherals such as a copier, a printer, and a facsimile, a toner image is formed by supplying toner from a developing apparatus to an electrostatic latent image formed on a photoconductor. The developing apparatus is constituted by a developing tank, a toner replenisher, a developer (toner, carrier), a developer stirring and conveyance member, a developer carrier (magnetic roller), a regulation member, and the like.

The replenished toner is stirred and conveyed together with the developer by the developer stirring and conveyance member in the developing tank and, after reaching a predetermined charge amount, is supplied onto the developer carrier via the developer supplying member. An excessive amount of the supplied developer is leveled off in the gap between the blade-shaped regulation member and the developer carrier, and thus, the amount of the developer to be conveyed becomes uniform, and the developer is conveyed as it is to a section facing the photoconductor, and developing is performed.

In a photoconductor section, a photosensitive drum charged by a charger is exposed and scanned by a light beam emitted from an exposer. Thus, an electrostatic latent image is formed on the photosensitive drum, and the electrostatic latent image is developed with a developer (herein, a two-component developer containing toner and carrier) in a developing section, and a toner image in a corresponding color is formed on the photosensitive drum.

As described above, basically, toner is developed only on an electrostatic latent image section on the photoconductor, but toner that is less likely to be affected by an electric field, such as toner having a low charge amount, also adheres to a part other than the electrostatic latent image. This toner is called fog toner, and when the fog toner adheres in an amount equal to or greater than a certain amount, the fog toner can be visually confirmed, which causes deterioration in image quality (fog image).

Examples of a method of suppressing the fog toner include a method of increasing a fog margin (a difference between a charging potential and a developing potential) (see FIG. 1). When the fog margin is small, the toner is likely to move to a portion other than the latent image, the fog toner amount increases, and the image quality deteriorates. When the fog margin is increased, the fog toner amount decreases, but carrier adhesion in which the carrier adheres onto the photoconductor occurs, and a stationary layer that is supplied to a cleaning blade decreases, with the result that cleaning failure occurs.

In addition, the fog toner amount is determined depending on the fog margin, the charge amount of toner (environment, stirring state, and the like), the distance between the photoconductor and the developing roller, and the like. Usually, the setting value of the fog margin is provided for each environment and for each life, and the fog toner amount is controlled while switching the fog margin to the setting value corresponding to a condition(s). However, the optimum fog margin changes due to environmental changes and unit individual variations, and thus, the required fog margin varies depending on each operating apparatus.

In order to cope with such a change, in Japanese Patent Application Laid-Open No. 2023-58347, a dedicated sequence is provided, and control is performed such that a fog toner amount is detected while a fog margin is changed in steps, and the fog margin is set based on the detection result. Thus, stable image quality can be maintained even when various changes (environment, endurance, and configuration difference) occur.

Incidentally, in order to perform the above-described control, a dedicated detection pattern has to be printed for a certain distance, and printing cannot be performed for the driving time, and thus, a reduction in productivity and consumption of a unit lifetime occur. From the viewpoint of productivity and life, it is more advantageous as the interval of the above-described control becomes longer, but in this case, followability for setting the optimum fog margin with respect to various changes decreases.

### SUMMARY

An object of the present invention is to provide an image forming apparatus, a fog margin setting method, and a non-transitory computer-readable recording medium storing a fog margin setting program, each of which is capable of suppressing a decrease in productivity and lifetime while maintaining stability of image quality by following a change.

In order to achieve at least one of the above-mentioned objects, an image forming apparatus reflecting one aspect of the present invention includes:

at least one hardware processor that controls an image former such that the image former forms a detection image with toner by setting a fog margin, which is a potential difference between a charging potential of a photoconductor and a developing potential of a developing apparatus, to a detection potential difference at a timing between a plurality of sheets during a print job; and

a detector that detects a toner amount or a value related to the toner amount in the formed detection image.

The at least one hardware processor sets, based on the detected toner amount or the detected value, the fog margin when a print image is formed.

In order to achieve at least one of the above-described objects, a fog margin setting method reflecting one aspect of the present invention includes:

forming, by an image former, a detection image with toner by setting a fog margin, which is a potential difference between a charging potential of a photoconductor and a developing potential of a developing apparatus, to a detection potential difference at a timing between a plurality of sheets during a print job;

detecting, by a detector, a toner amount or a value related to the toner amount in the formed detection image; and

setting, based on the detected toner amount or the detected value, the fog margin when a print image is formed.

In order to achieve at least one of the above-described objects, a non-transitory computer-readable recording medium storing a fog margin setting program reflecting one aspect of the present invention is a non-transitory computer-readable recording medium storing a fog margin setting program that causes a computer to execute:

forming, by an image former, a detection image with toner by setting a fog margin, which is a potential difference between a charging potential of a photoconductor and a developing potential of a developing apparatus, to a detection potential difference at a timing between a plurality of sheets during a print job; detecting, by a detector, a toner amount or a value related to the toner amount in the formed detection image; and setting, based on the detected toner amount or the detected value, the fog margin when a print image is formed.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram provided for describing a fog margin;

FIG. 2 is a diagram illustrating an example of an image forming apparatus according to an embodiment of the present invention;

FIG. 3 is a flowchart illustrating a fog margin setting method according to the embodiment of the present invention;

FIG. 4 is a diagram provided for describing a formation pattern for forming a plurality of detection images between sheets;

FIG. 5 is graph provided for describing the relationship between a fog margin and a sensor output value;

FIG. 6 is a graph provided for describing the relationship between the fog margin and the sensor output value in different fog states;

FIG. 7 is a graph provided for describing the relationship between the sensor output value and first and second thresholds;

FIG. 8 is a graph provided for describing the relationship between the sensor output value and the first threshold to a fourth threshold;

FIG. 9 is a flowchart illustrating a variation (Variation 1) of the flowchart illustrated in FIG. 3;

FIG. 10 is a diagram provided for describing a formation pattern for forming a plurality of detection images between one pair of sheets or a plurality of pairs of sheets;

FIG. 11 is a diagram provided for describing that a graph is obtained from a detection potential difference and a sensor output value and the slope of the graph is obtained;

FIG. 12 is a graph provided for describing the relationship between a slope of a graph of a sensor output value and a fog margin required at the time of the image formation of a print image;

FIG. 13 is a flowchart illustrating a variation (Variation 2) of the flowchart illustrated in FIG. 3; and

FIG. 14 is a diagram provided for describing setting ranges of detection potential differences in different fog states.

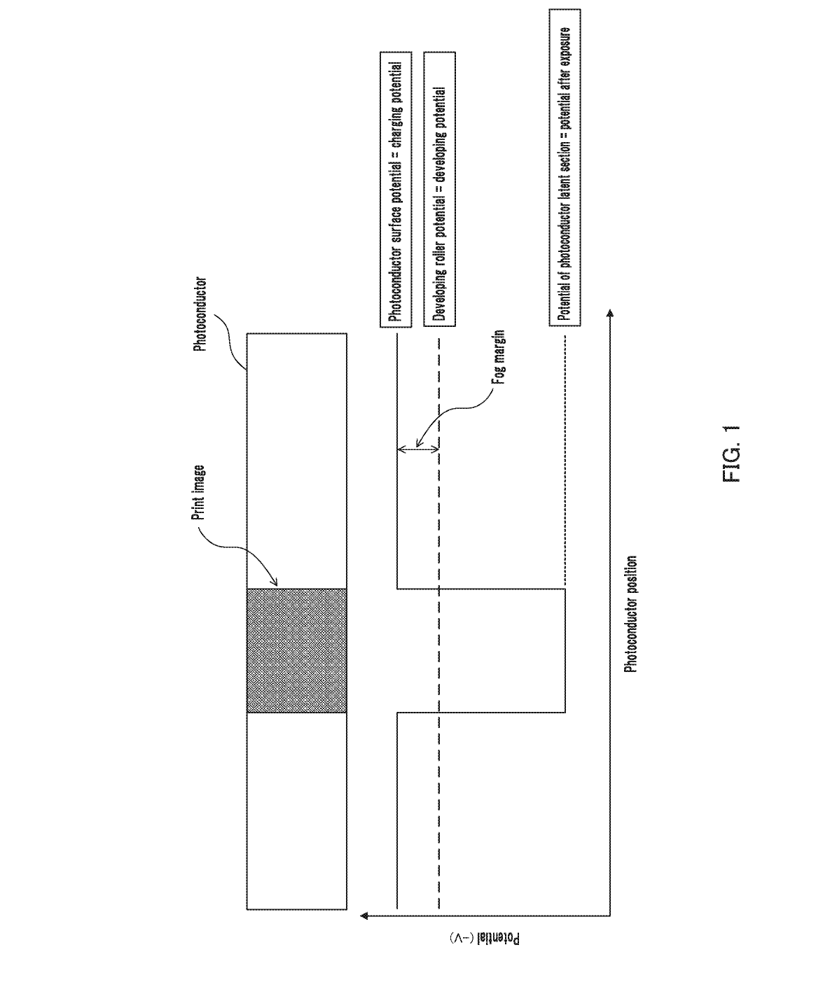

### DETAILED DESCRIPTION OF EMBODIMENTS

Hereinafter, one or more embodiments of the present invention will be described with reference to the drawings. However, the scope of the invention is not limited to the disclosed embodiments.

Hereinafter, an embodiment of the present invention will be described in detail with reference to the accompanying drawings.

### Image Forming Apparatus

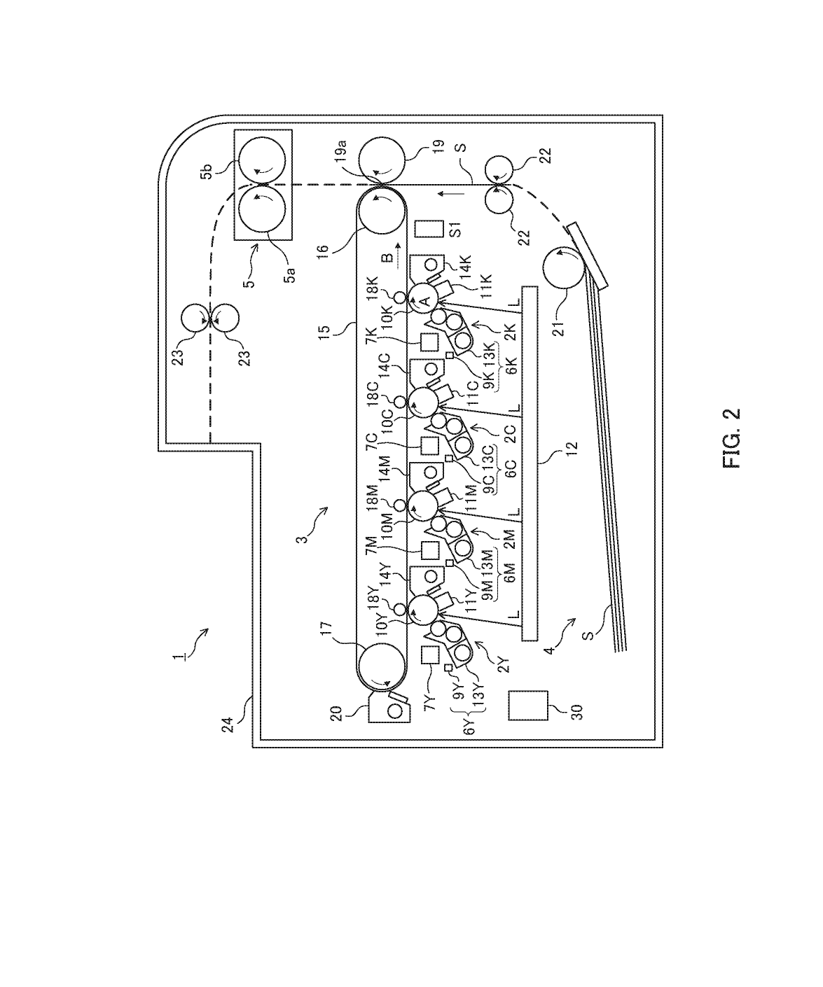

FIG. 2 is a diagram illustrating an image forming apparatus 1 as an example of an image forming apparatus according to the present embodiment. As illustrated in FIG. 2, the image forming apparatus 1 includes image creators 2Y, 2M, 2C, and 2K corresponding to reproduction colors of yellow (Y), magenta (M), cyan (C), and black (K), an intermediate transferer 3, a feeder 4, a fixer 5, and the like.

The image forming apparatus 1 is connected to an external terminal apparatus (not illustrated) via a network (for example, a local area network (LAN)). When an instruction to execute a print job is received from an external terminal apparatus, the image forming apparatus 1 forms toner images of yellow (Y), magenta (M), cyan (C), and black (K) based on the instruction, and transfers the formed toner images onto a sheet S for recording to form a color image. In addition, the image forming apparatus 1 is also capable of selectively executing the formation of a monochrome image with only a black (K) toner image.

The image creators 2Y, 2M, 2C, and 2K are arranged side by side in this order along the traveling direction (the direction of an arrow B) of an intermediate transfer belt 15 of the intermediate transferer 3.

The image creator 2K includes a photosensitive drum 10K, which rotates in the direction of an arrow A, a charger 11K, a developing section 13K, a cleaner 14K, and the like, and creates a toner image of the K color on the photosensitive drum 10K.

The other image creators 2Y, 2M, and 2C have basically the same configuration as the image creator 2K. That is, the image creators 2Y, 2M, and 2C include photosensitive drums 10Y, 10M, and 10C, chargers 11Y, 11M, and 11C, developing sections 13Y, 13M, and 13C, and cleaners 14Y, 14M, and 14C, respectively. Then, the image creators 2Y, 2M, and 2C create toner images of Y, M, and C colors on the photosensitive drums 10Y, 10M, and 10C, respectively.

The intermediate transferer 3 is disposed above the image creators 2Y, 2M, 2C, and 2K in FIG. 2. That is, the intermediate transferer 3 is disposed on the downstream side of the image creators 2Y, 2M, 2C, and 2K in the conveyance direction of the sheet S. The intermediate transferer 3 includes the intermediate transfer belt 15, a drive roller 16, a driven roller 17, primary transfer rollers 18Y, 18M, 18C, and 18K, a secondary transfer roller 19, a cleaner 20, and the like.

The intermediate transfer belt 15 is stretched over the drive roller 16, the driven roller 17, and the primary transfer rollers 18Y, 18M, 18C, and 18K, and is driven in a circular manner in the direction of the arrow B.

The primary transfer rollers 18Y, 18M, 18C, and 18K are disposed to face the corresponding photosensitive drums 10Y, 10M, 10C, and 10K, respectively, via the intermediate transfer belt 15. The secondary transfer roller 19 is disposed to face the drive roller 16 via the intermediate transfer belt 15. The position at which the secondary transfer roller 19 is in contact with the intermediate transfer belt 15 is a secondary transfer position 19a.

An exposer 12 is disposed below the image creators 2Y, 2M, 2C, and 2K in FIG. 2, and emits light beams L for image formation in the Y, M, C, and K colors from light emitting elements, respectively, in response to drive signals from a controller 30 to be described later.

The photosensitive drums 10Y, 10M, 10C, and 10K charged by the chargers 11Y, 11M, 11C, and 11K, respectively, are exposed and scanned by the light beams L emitted from the exposer 12, and electrostatic latent images are formed on the photosensitive drums 10Y, 10M, 10C, and 10K, respectively. Then, the formed electrostatic latent images are developed with developers (here, two-component developers containing toner and carrier) in the developing sections 13Y, 13M, 13C, and 13K, respectively, and toner images in the corresponding colors are formed on the photosensitive drums 10Y, 10M, 10C, and 10K, respectively.

The toner images of the Y, M, C, and K colors formed on the photosensitive drums 10Y, 10M, 10C, and 10K, respectively, are primarily-transferred onto the intermediate transfer belt 15 by the electrostatic action of the primary transfer rollers 18Y, 18M, 18C, and 18K. At this time, the image forming operations for the respective colors are performed at different timings such that the toner images are transferred onto the same position on the intermediate transfer belt 15 in a superimposed manner. Note that, of the toner images on the photosensitive drums 10Y, 10M, 10C, and 10K, residual toner that has not been transferred onto the intermediate transfer belt 15 and remains on the photosensitive drums during the primary transfer is removed by the cleaners 14Y, 14M, 14C, and 14K.

The toner images of the Y, M, C, and K colors transferred onto the intermediate transfer belt 15 in a superimposed manner move to the secondary transfer position 19a by the circular traveling of the intermediate transfer belt 15.

The image creators 2Y, 2M, 2C, 2K, and the intermediate transferer 3 that have described above constitute the image former in the present invention, which forms a print image, and a detection image to be described later.

The feeder 4 feeds out the sheet S for recording, which is accommodated in a sheet feed cassette (not illustrated), to a conveyance path (the broken line) by a feeding roller 21 and conveys the sheet S to a timing roller 22 which is stopped.

The timing roller 22 starts rotating in line with the timing at which the Y, M, C, and K color toner images, which have been transferred in a superimposed manner onto the intermediate transfer belt 15 that is in circulation, reach the secondary transfer position 19a, and conveys the sheet S to the secondary transfer position 19a.

When the sheet S passes through the secondary transfer position 19a, the toner images of the Y, M, C, and K colors, which have been transferred in a superimposed manner onto the intermediate transfer belt 15, are secondarily-transferred onto the sheet S by the electrostatic action of the secondary transfer roller 19. Thus, a color toner image is formed on the sheet S. Note that, of the toner images on the intermediate transfer belt 15, residual toner that has not been transferred onto the sheet S and remains on the intermediate transfer belt 15 during the secondary transfer is conveyed to the cleaner 20 by the circular traveling of the intermediate transfer belt 15, and is removed from the intermediate transfer belt 15 by the cleaner 20.

The sheet S onto which the color toner image has been secondarily-transferred at the secondary transfer position 19a is conveyed to the fixer 5. The fixer 5 includes a heating roller 5a and a pressure roller 5b that comes in pressure contact with the heating roller 5a to form a fixing nip, and when the sheet S conveyed by the secondary transfer roller 19 passes through the fixing nip, the fixer 5 heat-fixes the color toner image (unfixed image) on the sheet S by heating and pressurizing. The sheet S which has passed through the fixer 5 is discharged to the outside of the apparatus by the discharge roller 23 and is accommodated in the sheet ejection tray 24.

The operations of color printing have been described above. In monochrome printing, after only the image creator 2K is used to create a K color toner image on the photosensitive drum 10K , each process is executed in the order of primary transfer from the photosensitive drum 10K onto the intermediate transfer belt 15, secondary transfer to the sheet S, and fixing to the sheet S. As described above, in the image forming apparatus 1, each process is executed in the order of charging, exposure, developing, transfer, and fixing.

In FIG. 2, toner hoppers 7Y, 7M, 7C, and 7K that supply toner for replenishment to the developing sections 13Y, 13M, 13C, and 13K, respectively, are disposed at positions immediately above the developing sections 13Y, 13M, 13C, and 13K, respectively.

The toner hopper 7Y supplies new toner of the Y color for replenishment to the developing section 13Y according to a toner replenishment amount of the Y color instructed from a toner concentration controller 9Y to be described later. The other toner hoppers 7M, 7C, and 7K have basically the same configuration as the toner hopper 7Y. That is, the toner hoppers 7M, 7C, and 7K supply new toners of the M, C, and K colors for replenishment to the developing sections 13M, 13C, and 13K according to the toner replenishment amounts of the M, C, and K colors instructed from toner concentration controllers 9M, 9C, and 9K to be described later, respectively.

The toner concentration controllers 9Y, 9M, 9C, and 9K are disposed in the vicinity of the developing sections 13Y, 13M, 13C, and 13K, respectively. The toner concentration controllers 9Y, 9M, 9C, and 9K control the toner amount to be supplied from the toner hoppers 7Y, 7M, 7C, and 7K to the respective developing sections 13Y, 13M, 13C, and 13K, thereby controlling such that the toner concentrations in the respective developing sections 13Y, 13M, 13C, and 13K are constant. Note that, the developing section 13Y and the toner concentration controller 9Y may also be collectively referred to as a developing apparatus 6Y. In the same manner, the developing sections 13M, 13C, and 13K and the toner concentration controllers 9M, 9C, and 9K may also be collectively referred to as developing apparatuses 6M, 6C, and 6K, respectively.

An optical sensor S1 (the detector in the present invention) emits light and measures the intensity of the reflected light to detect the amount of toner on the intermediate transfer belt 15 or a sensor output value related to the toner amount. Note that, instead of the optical sensor S1 described above, a sensor that detects the amount of toner on each of the photosensitive drums 10Y, 10M, 10C, and 10K or a sensor value related to each toner amount may also be used.

The controller 30 is, for example, a computer including at least one hardware processor, and includes a central processing unit (CPU), a read only memory (ROM), a random access memory (RAM), and the like. The CPU reads a control program from a storage such as the ROM, develops the program in the RAM, and centrally controls the operation of each block constituting the image forming apparatus 1 in cooperation with the developed control program. In the case of the present embodiment, the controller 30 executes a fog margin setting program included in a control program, as described later. The fog margin setting program is stored in a non-transitory computer-readable recording medium, and is stored in the storage from the recording medium.

### Fog Margin Setting Method

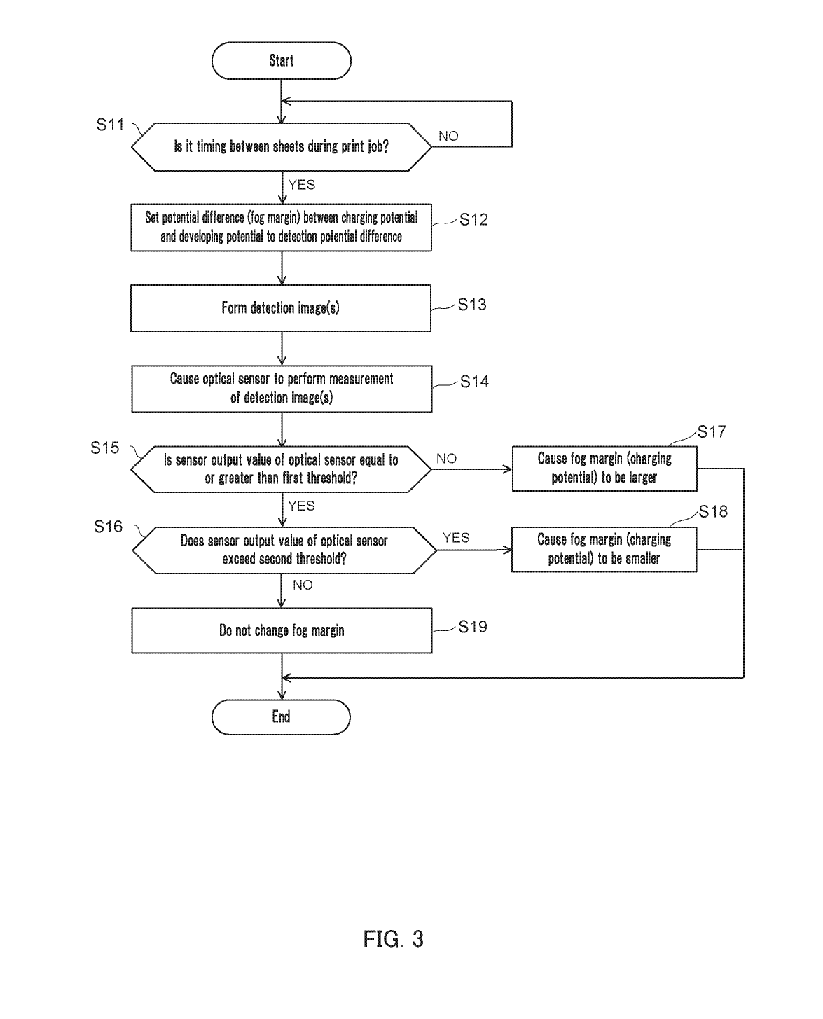

FIG. 3 is a flowchart illustrating a fog margin setting method according to the present embodiment. The fog margin setting method that will be described below is executed by the controller 30 executing a fog margin setting program included in a control program.

### Step S11

The controller 30 determines whether it is a timing between sheets during a print job. In a case where it is a timing between sheets during a print job (YES), the controller proceeds to step S12, whereas in a case where it is not a timing between sheets during a print job (NO), the controller repeats step S11. That is, the controller 30 repeats step S11 until it is a timing between sheets during a print job.

### Step S12

When it is a timing between sheets during a print job, the controller 30 controls the image creators 2Y, 2M, 2C, and 2K such that the potential difference (fog margin) between the charging potential and the developing potential is set to a detection potential difference. At this time, the controller 30 performs control such that one or both of the charging potential and the developing potential is or are changed to set the fog margin to the detection potential difference.

### Step S13

The controller 30 controls the image creators 2Y, 2M, 2C, and 2K and the intermediate transferer 3 such that a detection image(s) with toner is formed on the intermediate transfer belt 15 without exposure. The controller 30 may perform control such that one detection image is formed between the sheets, or may perform control such that a plurality of detection images is formed between the sheets.

Unlike a print image formed based on a print job, a detection image(s) is/are formed without exposing the photosensitive drums 10Y, 10M, 10C, and 10K by the exposer 12. In the formed detection image(s), as described later, a sensor output value related to a fog toner amount is measured in order to control such that an appropriate fog margin is realized at the time of image formation of the print image.

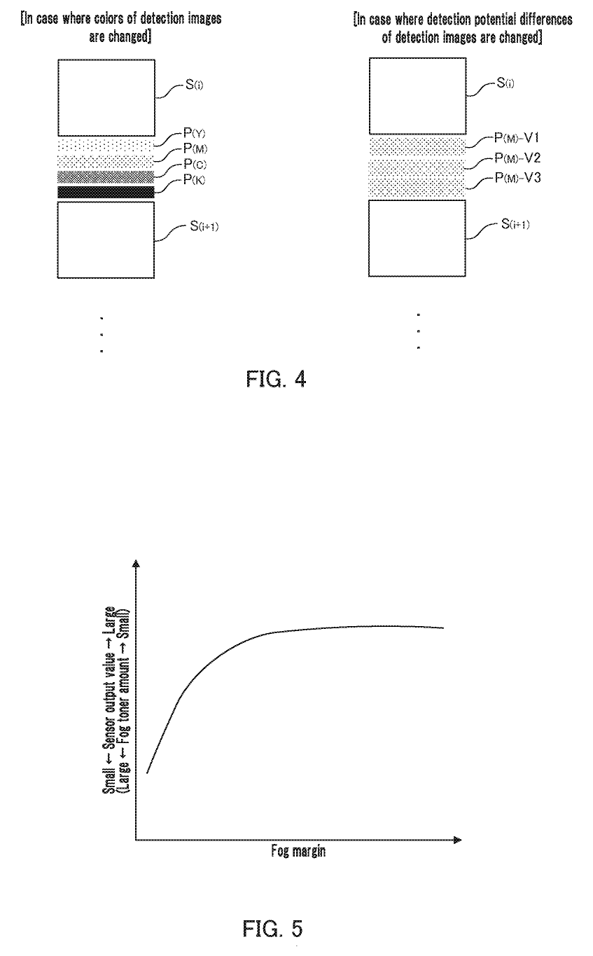

Here, an example of a formation pattern in a case where a plurality of detection images is formed between sheets will be described with reference to FIG. 4. FIG. 4 is a diagram provided for describing a formation pattern for forming a plurality of detection images between sheets.

FIG. 4 illustrates a case where a plurality of detection images is formed between sheets, for example, between an i-th sheet S (i) and an (i + 1)-th sheet S (i + 1), where i is a positive integer. In a case where the colors of detection images are changed between the sheets, the controller 30 performs control such that detection images P (Y), P (M), P (C), and P (K) are formed correspondingly to the Y, M, C, and K colors, respectively, as illustrated on the left side in FIG. 4, with a constant detection potential difference for all the colors.

Note that, although the number of colors can be changed as appropriate, the controller 30 changes the number of colors of detection images formed between one pair of sheets according to whether the image quality or the detection accuracy is prioritized. In a case where the image quality is prioritized, it is desirable to increase the number of colors, for example, four colors are set. In a case where the detection accuracy is prioritized, on the other hand, it is desirable to reduce the number of colors, for example, one color is set, and detection images are formed with a plurality of detection potentials as described below.

In addition, in a case where the detection potential differences of detection images are changed between the sheets, the controller 30 performs control such that detection images P (M)-V1, P (M)-V2, and P (M)-V3 are formed correspondingly to a plurality of detection potential differences, respectively, as illustrated on the right side in FIG. 4, without changing the color of the detection images. Note that, although a case where the detection potential differences are set to V1, V2, and V3 in the case of the M color is illustrated as an example here, the color may also be the other Y, C, or K color, and the number of detection potential differences to be changed, that is, the number of detection images to be formed can also be changed as appropriate.

### Step S14

The controller 30 causes the optical sensor S1 to measure the detection image(s) formed on the intermediate transfer belt 15.

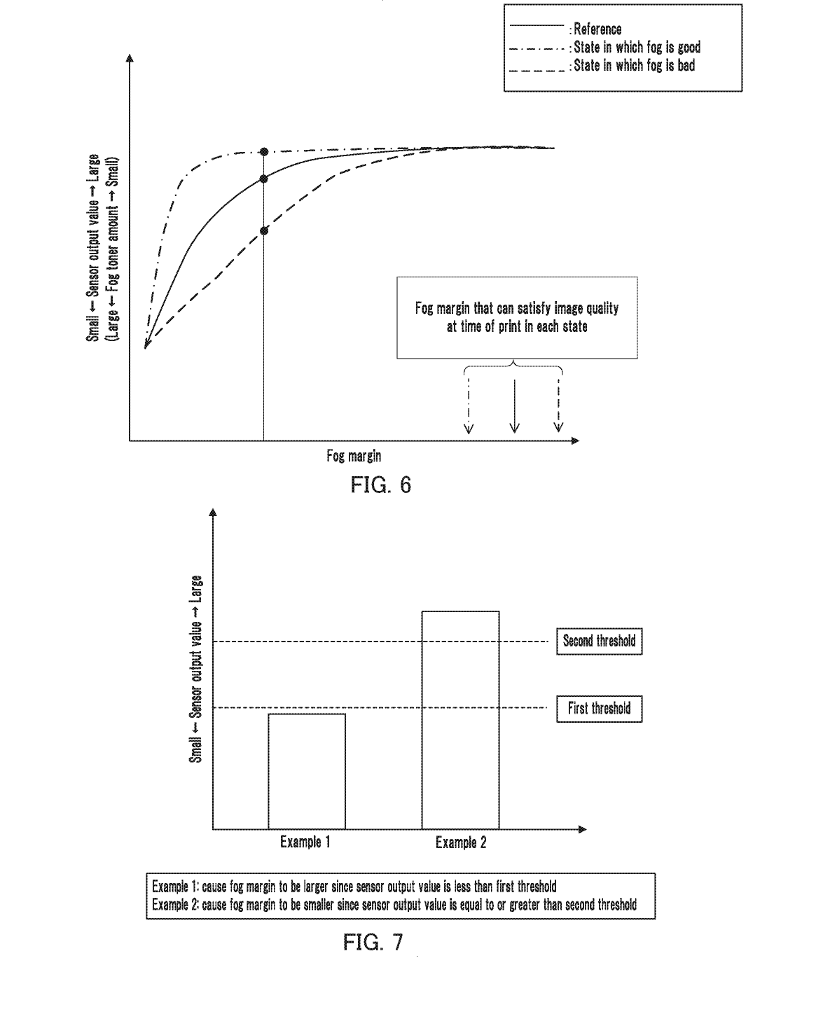

Here, the relationship between a detection image formed by changing the fog margin and the sensor output value of the optical sensor S1 which has performed measurement of the detection image will be described with reference to FIGS. 5 and 6. FIG. 5 is a graph provided for describing the relationship between a fog margin and the sensor output value of the optical sensor S1. FIG. 6 is a graph provided for describing the relationship between the fog margin and the sensor output value of the optical sensor S1 in different fog states.

In the graphs illustrated in FIGS. 5 and 6, the horizontal axis represents the fog margin, and the vertical axis represents the sensor output value of the optical sensor S1 that has performed measurement of a detection image.

The optical sensor S1 measures the reflectance of a detection image. When the toner amount of a detection image, that is, the above-described fog toner amount decreases, the reflectance of the detection image increases, and the sensor output value of the optical sensor S1 is saturated and becomes a constant value. In addition, when the fog margin increases, the fog toner amount decreases, and thus, the sensor output value of the optical sensor S1 is becoming saturated as illustrated in FIG. 5. As described above, the sensor output value of the optical sensor S1 indicates the fog toner amount, although the magnitude relationship is reversed.

In addition, the relationship between the fog margin and the sensor output value of the optical sensor S1 varies depending on external factors such as environmental changes and developer deterioration. Assuming that a reference is a solid line, a state in which the fog is good (the fog toner amount is small) is indicated by a one-dot-chain line, and a state in which the fog is bad (the fog toner amount is large) is indicated by a broken line, the relationship between the fog margin and the sensor output value of the optical sensor S1 is as illustrated in FIG. 6.

In the graph illustrated in FIG. 6, when compared at the same fog margins (the fog margins indicated by the black circles), the fog toner amount tends to be small in a state in which the fog is good, whereas the fog toner amount tends to be large in a state in which the fog is bad. For this reason, the fog margin that can satisfy the image quality at the time of the image formation of a print image varies depending on the state of fog, as indicated by the solid-line arrow, the one-dot-chain-line arrow, and the broken-line arrow in FIG. 6.

Here, first and second thresholds used in steps S15 and S16 will be described. The first threshold is a sensor output value corresponding to the upper limit value of a fog toner amount that allows a good image quality to be maintained. In addition, the second threshold is a sensor output value corresponding to the lower limit value of a fog toner amount that allows a good cleaning performance to be maintained. As described above, since the magnitude of the fog toner amount and the magnitude of the sensor output value have a reversed relationship, the first threshold is the lower limit value of the sensor output value, and the second threshold is the upper limit value of the sensor output value and is larger than the first threshold.

Note that, in a case where the following determination is performed using the fog toner amount instead of the sensor output value, it is assumed that the first threshold is the lower limit of the fog toner amount that allows a good cleaning performance to be maintained, and that the second threshold is the upper limit of the fog toner amount that allows a good image quality to be maintained.

### Step S15

The controller 30 determines whether the sensor output value of the optical sensor S1 that has performed measurement of a detection image is equal to or greater than the first threshold. In a case where the sensor output value is equal to or greater than the first threshold (YES), the controller 30 proceeds to step S16, whereas in a case where the sensor output value is not equal to or greater than the first threshold (NO), the controller 30 proceeds to step S17.

Note that, when the fog toner amount is used instead of the sensor output value, the controller 30 proceeds to step S16 in a case where the fog toner amount is equal to or greater than the first threshold (YES), whereas the controller 30 proceeds to step S18 instead of step S17 in a case where the fog toner amount is not equal to or greater than the first threshold (NO).

### Step S16

The controller 30 determines whether the sensor output value of the optical sensor S1 that has performed measurement of the detection image exceeds the second threshold. In a case where the sensor output value exceeds the second threshold (YES), the controller 30 proceeds to step S18, whereas in a case where the sensor output value does not exceed the second threshold (NO), the controller 30 proceeds to step S19.

Note that, when the fog toner amount is used instead of the sensor output value, the controller 30 proceeds to step S17 instead of step S18 in a case where the fog toner amount exceeds the second threshold (YES), whereas the controller 30 proceeds to step S19 in a case where the fog toner amount does not exceed the second threshold (NO).

### Step S17

In a case where the sensor output value is not equal to or greater than the first threshold, that is, in a case where the sensor output value is less than the first threshold, the controller 30 controls the image creators 2Y, 2M, 2C, and 2K such that the fog margin when the print image is formed is caused to be larger than the fog margin before the change. For example, the controller 30 performs control such that the charging potential is caused to be larger than that before the change, thereby causing the fog margin to be larger. Thus, the fog toner amount is caused to be smaller than that before the change. At this time, since the controller 30 causes, based on the sensor output value, the fog margin, when the print image is formed, to be larger, the controller 30 sets that the detection potential difference to be used between the next pair of sheets is also larger than that before the change.

### Step S18

In a case where the sensor output value exceeds the second threshold, the controller 30 controls the image creators 2Y, 2M, 2C, and 2K such that the fog margin when the print image is formed is caused to be smaller than the fog margin before the change. For example, the controller 30 performs control such that the charging potential is caused to be smaller than that before the change, thereby causing the fog margin to be smaller. Thus, the fog toner amount is caused to be larger than that before the change. At this time, since the controller 30 causes, based on the sensor output value, the fog margin, when the print image is formed, to be smaller, the controller 30 sets that the detection potential difference to be used between the next pair of sheets is also smaller than that before the change.

Note that, in a case where the fog toner amount is not equal to or greater than the first threshold (the fog toner amount is less than the first threshold), the controller 30 performs step S18 described above. That is, the controller 30 causes the fog margin, when the print image is formed, to be smaller than the fog margin before the change, thereby causing the fog toner amount to be larger than before the change.

In addition, in a case where the fog toner amount exceeds the second threshold, the controller 30 performs step S17 described above. That is, the controller 30 causes the fog margin, when the print image is formed, to be larger than the fog margin before the change, thereby causing the fog toner amount to be smaller than that before the change.

### Step S19

In a case where the sensor output value (or the fog toner amount) is equal to or greater than the first threshold and equal to or less than the second threshold, the controller 30 determines that there is a small change in the fog state, does not perform the control for changing the fog margin when the print image is formed, and causes the fog margin before the change to remain.

As described above, the controller 30 controls the fog margin when the print image is formed, according to the sensor output value (or the fog toner amount) of the optical sensor S1 that has performed measurement of the detection image.

Here, steps S15 to S19 will be described with reference to FIG. 7. FIG. 7 is a graph provided for describing the relationship between the sensor output value and the first and second thresholds.

In FIG. 7, the sensor output value indicated in Example 1 is less than the first threshold. That is, in the case of the sensor output value indicated in Example 1, the result in step S15 is “NO”. In this case, the controller 30 performs the processing described in step S17.

In addition, in FIG. 7, the sensor output value indicated in Example 2 exceeds the second threshold. That is, in the case of the sensor output value indicated in Example 2, the result in step S16 is “YES”. In this case, the controller 30 performs the processing described in step S18.

In the case of changing the charging potential, it is desirable that the change in the charging potential be limited to 10 V to 30 V because when the charging potential is largely changed, a color tone may change and another image failure may occur.

In a case where the sensor output value is equal to or greater than the first threshold and equal to or less than the second threshold, on the other hand, the result in step S15 is “YES” and the result in step S16 is “NO”. In this case, the controller 30 performs the processing described in step S19.

In this way, the controller 30 controls the fog margin when the print image is formed such that the sensor output value (or the fog toner amount) is equal to or greater than the first threshold and equal to or less than the second threshold.

The fog margin setting method described above may be executed between every pair of sheets, but the execution interval can be appropriately changed, for example, such that the fog margin setting method is executed for every 100 sheets.

Note that, the fog state greatly changes depending on the developer, the apparatus configuration, and the like, and the sensor output value also greatly changes. In a case where the fog state greatly changes, it may be configured, for example, in the flowchart illustrated in FIG. 3, such that third and fourth thresholds for determining whether the sensor output value has greatly changed from the first and second thresholds are further provided, and that the processing to be described below is performed.

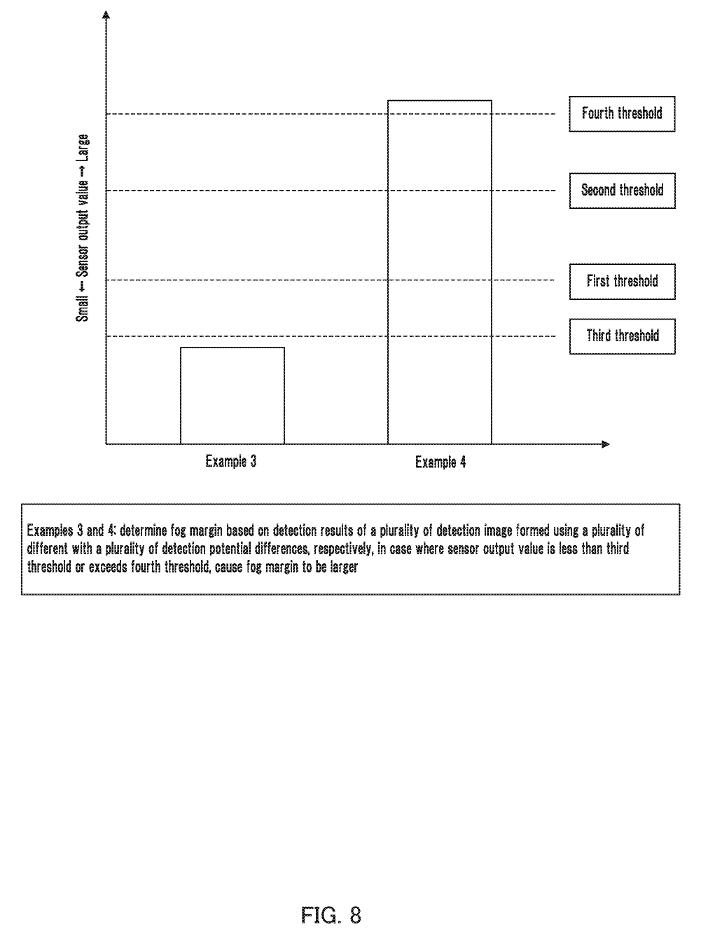

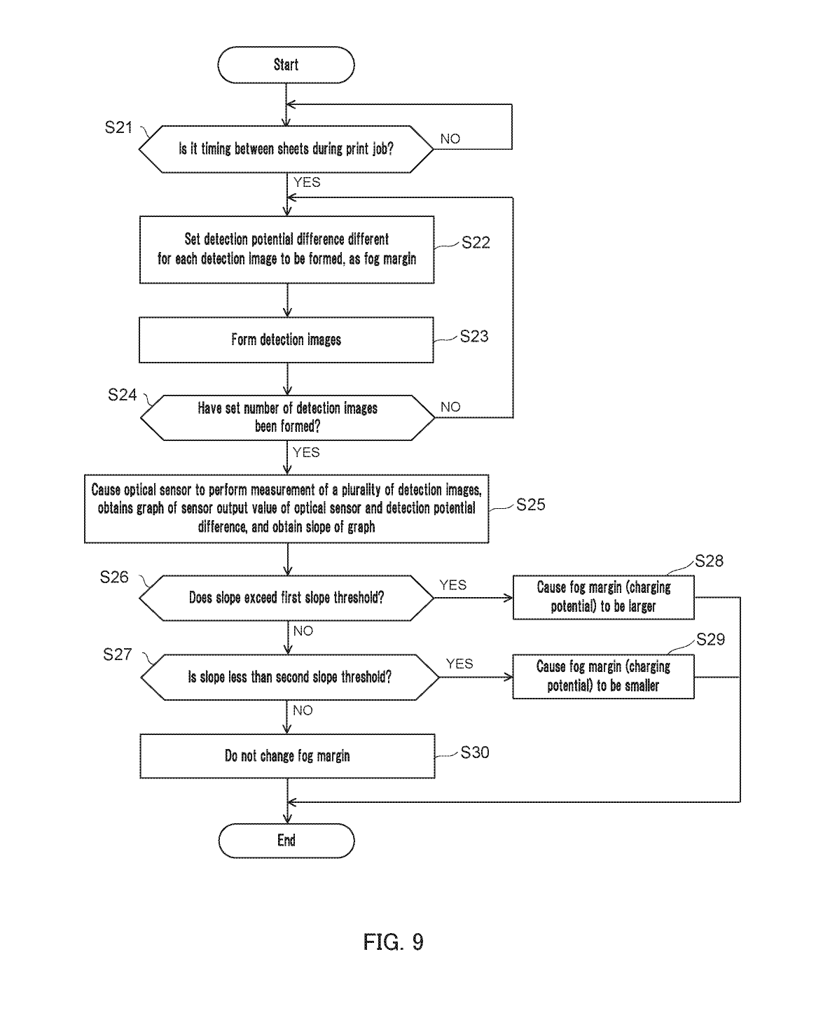

Here, FIG. 8 is a graph provided for describing the relationship between the sensor output value and the first threshold to the fourth threshold.

In FIG. 8, the sensor output value indicated in Example 3 is less than the third threshold. The third threshold is a threshold that smaller than the first threshold and is used to determine whether the sensor output value has greatly changed in the decreasing direction. In a case where the sensor output value is less than the first threshold and equal to or greater than the third threshold, the controller 30 may perform the processing described in step S17. In a case where the sensor output value is less than the third threshold as illustrated in Example 3, on the other hand, the controller 30 performs processing to be described later.

In addition, in FIG. 8, the sensor output value indicated in Example 4 exceeds the fourth threshold. The fourth threshold is a threshold that is larger than the second threshold and is used to determine whether the sensor output value has greatly changed in the increasing direction. In a case where the sensor output value exceeds the second threshold and is equal to or less than the fourth threshold, the controller 30 may perform the processing described in step S18. In a case where the sensor output value exceeds the fourth threshold as illustrated in Example 4, on the other hand, the controller 30 performs processing to be described later.

Note that, even in a case where the fog toner amount is used instead of the sensor output value, the fourth threshold is a threshold that is larger than the second threshold and is used to determine whether the fog toner amount has greatly changed in the increasing direction. In addition, the third threshold is a threshold that is smaller than the first threshold and is used to determine whether the fog toner amount has greatly changed in the decreasing direction. In this case, in a case where the fog toner amount exceeds the second threshold and is equal to or less than the fourth threshold, the controller 30 may perform the processing described in step S17, whereas in a case where the fog toner amount is less than the first threshold and is equal to or greater than the third threshold, the controller 30 may perform the processing described in step S18. In a case where the fog toner amount is less than the third threshold or in a case where the fog toner amount exceeds the fourth threshold, on the other hand, the controller 30 performs processing to be described later.

In a case where the sensor output value (or the fog toner amount) is less than the third threshold or in a case where the sensor output value (or the fog toner amount) exceeds the fourth threshold, the controller 30 causes detection images to be formed with a plurality of different detection potential differences, respectively, at a predetermined timing. Then, the controller 30 causes the optical sensor S1 to perform measurement of a plurality of the formed detection images, and changes the fog margin (for example, the charging potential) based on the sensor output values or fog toner amounts obtained by the measurement. This processing is performed in a dedicated sequence at a timing other than a timing between sheets, for example, when waiting for a print job. At this time, since color tone changes when the charging potential is greatly changed, it is desirable that the controller 30 should execute adjustment of the toner adhesion amount and adjustment of the laser light amount to suppress color tone fluctuation.

As described above, the image forming apparatus 1 includes the image creators 2Y, 2M, 2C, and 2K and the intermediate transferer 3 that function as the image former, the optical sensor S1 that functions as the detector, the controller 30, and the like. The image creators 2Y, 2M, 2C, and 2K, and the intermediate transferer 3 are controlled by the controller 30 to form a detection image with toner by setting a fog margin to a detection potential difference at a timing between sheets during a print job. The optical sensor S1 detects a sensor output value related to a fog toner amount in the formed detection image. The controller 30 controls, based on the detected sensor output value, the fog margin when the print image is formed.

As described above, the image forming apparatus 1 forms a detection image at a timing between sheets during a print job, and controls, based on a sensor output value obtained by performing measurement of the formed detection image, a fog margin when a print image is formed. The image forming apparatus 1 controls the fog margin by processing between sheets and is therefore capable of maintaining, even when the environment, the state of the developer, or the like changes over time and the fog state changes, the stability of the image quality by following the change over time, as well as a decrease in the productivity or the apparatus life can be suppressed.

### Variation 1

In the present modification, the image forming apparatus 1 described above is used as the image forming apparatus. On the other hand, the present variation is different from the above-described embodiment in the fog margin setting method. Briefly, in the above-described embodiment, the fog margin at the time of the image formation of a print image is controlled based on a sensor output value obtained by performing measurement of a detection image as described with reference to FIG. 3. In the present variation, on the other hand, a slope of a graph of the detection potential difference and the sensor output value is obtained from a plurality of sensor output values obtained by performing measurement of a plurality of detection images different in detection potential difference, and the fog margin at the time of the image formation of a print image is controlled based on the obtained slope.

The fog margin setting method in the present variation will be described with reference to FIG. 9. FIG. 9 is a flowchart illustrating a variation (Variation 1) of the flowchart illustrated in FIG. 3.

### Step S21

Step S21 is substantially the same as step S11 described above, and the controller 30 determines whether it is a timing between sheets during a print job. In a case where it is a timing between sheets during a print job (YES), the controller 30 proceeds to step S22, whereas in a case where it is not a timing between sheets during a print job (NO), the controller 30 repeats step S21.

### Step S22

When it is a timing between sheets during a print job, the controller 30 controls the image creators 2Y, 2M, 2C, and 2K such that a detection potential difference different for each detection image to be formed is as a fog margin.

### Step S23

Step S23 is substantially the same as step S13 described above, and the controller 30 controls the image creators 2Y, 2M, 2C, and 2K and the intermediate transferer 3 such that detection images are formed on the intermediate transfer belt 15.

### Step S24

The controller 30 determines whether a set number of detection images have been formed. In a case where the set number of detection images have been formed (YES), the controller 30 proceeds to step S25, whereas in a case where the set number of detection images have not been formed (NO), the controller 30 returns to step S22. The number of detection images to be formed is set according to, for example, the time between sheets, or the like.

Note that, although the controller 30 causes a plurality of detection images to be formed between one pair of sheets here, the controller 30 may form a plurality of detection images between a plurality of pairs of sheets, in which case the controller 30 may return to step S21 when the result in step S24 is “NO”.

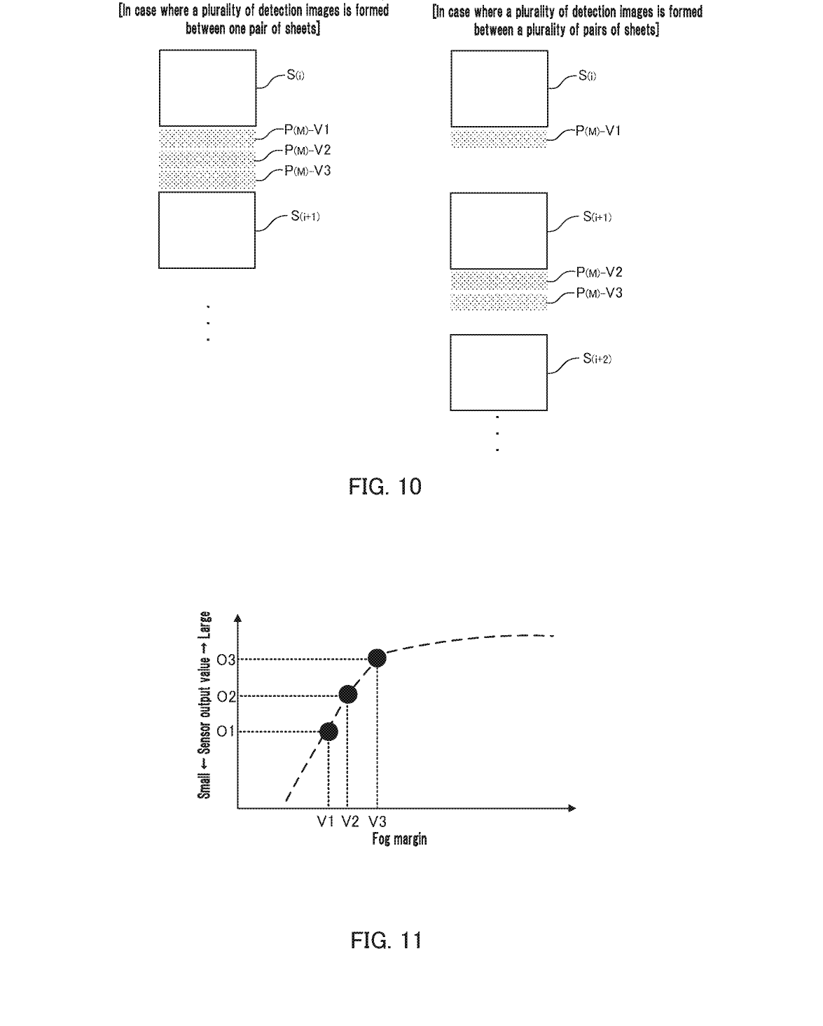

Here, an example of a formation pattern in a case where a plurality of detection images is formed between one pair of sheets or a plurality of pairs of sheets will be described with reference to FIG. 10. FIG. 10 is a diagram provided for describing a formation pattern for forming a plurality of detection images between one pair of sheet or a plurality of pairs of sheets.

The left diagram in FIG. 10 illustrates a case where a plurality of detection images is formed, for example, between one pair of sheets that are an i-th sheet S (i) and an (i + 1)-th sheet S (i + 1), where i is a positive integer. The controller 30 performs control such that detection images P (M)-V1, P (M)-V2, and P (M)-V3 are formed between the one pair of sheets by causing changes to detection potential differences V1, V2, and V3 different from each other as fog margins without changing the color of the detection images.

In addition, the right drawing in FIG. 10 illustrates a case where a plurality of detection images is formed, for example, between two pairs of sheets that are a pair of an i-th sheet S (i) and an i + 1-th sheet S (i + 1) and a pair of the i + 1-th sheet S (i + 1) and an i + 2-th sheet S (i + 2), where i is a positive integer. The controller 30 performs control such that detection images P (M)-V1, P (M)-V2, and P (M)-V3 are formed between the two pairs of sheets by causing changes to detection potential differences V1, V2, and V3 different from each other as fog margins without changing the color of the detection images. Here, as an example, the detection image P (M)-V1 is formed between one pair of the sheet S (i) and the sheet S (i + 1), and the detection images P (M)-V2 and P (M)-V3 are formed between one pair of the sheet S (i + 1) and the sheet S (i + 2).

Note that, although a case where the detection potential differences are set to V1, V2, and V3 in the case of the M color is illustrated as an example in FIG. 10, the color may be the other Y, C, or K color, and the number of detection potential differences to be changed, that is, the number of detection images to be formed can also be changed as appropriate.

### Step S25

The controller 30 causes the optical sensor S1 to perform each measurement of the plurality of detection images formed on the intermediate transfer belt 15, obtains a graph of the sensor output value of the optical sensor S1 and the detection potential difference, and obtains a slope of the graph. The graph illustrates the relationship between the detection potential difference and the sensor output value, and the slope is a change rate of the sensor output value with respect to the detection potential difference.

Here, FIG. 11 is a diagram provided for describing that a graph is obtained from the detection potential difference and the sensor output value and a slope of the graph is obtained.

As described above, the controller 30 sets the detection potential differences V1, V2, and V3 different from each other as fog margins, and controls the image creator 2M and the intermediate transferer 3 such that the detection images P (M)-V1, P (M)-V2, and P (M)-V3 are formed, respectively. Thereafter, the controller 30 uses the optical sensor S1 to perform measurement of the formed detection images P (M)-V1, P (M)-V2, and P (M)-V3, and acquires sensor output values O1, O2, and O3, respectively. Then, the controller 30 obtains the graph illustrated in FIG. 11 from the detection potential differences V1, V2, and V3 and the sensor output values O1, O2, and O3, and obtains a slope from the graph. For example, the controller 30 obtains the average slope from the amount of change among the sensor output values O1, O2, and O3 with respect to the amount of change among the detection potential differences V1, V2, and V3.

Even for the slope obtained in this way, the fog margin can be controlled by setting first and second slope thresholds and comparing the obtained slope with the first and second slope thresholds in the same manner as the first and second thresholds described above. Here, the first slope threshold is the upper limit value of a slope that allows a good cleaning performance to be maintained. In addition, the second threshold is the lower limit value of a slope that allows a good image quality to be maintained. The first slope threshold is larger than the second slope threshold.

### Step S26

The controller 30 determines whether the slope exceeds the first slope threshold. In a case where the slope exceeds the first slope threshold (YES), the controller 30 proceeds to step S28, whereas in a case where the slope does not exceed the first slope threshold (NO), the controller 30 proceeds to step S27.

### Step S27

The controller 30 determines whether the slope is less than the second slope threshold. In a case where the slope is less than the second slope threshold (YES), the controller 30 proceeds to step S29, whereas in a case where the slope is not less than the second slope threshold (NO), the controller 30 proceeds to step S30.

### Step S28

Since a case where the slope exceeds the first slope threshold means that the fog state is bad, the controller 30 controls the image creators 2Y, 2M, 2C, and 2K such that the fog margin when the print image is formed is caused to be larger than the fog margin before the change. For example, the controller 30 performs control such that the charging potential is caused to be larger than that before the change, thereby causing the fog margin to be larger. At this time, since the controller 30 causes the fog margin to be larger based on the slope, the controller 30 sets that the detection potential difference to be used between the next pair of sheets is also larger than that before the change.

### Step S29

Since a case where the slope is less than the second slope threshold means that the fog state is good, the controller 30 controls the image creators 2Y, 2M, 2C, and 2K such that the fog margin when the print image is formed is caused to be smaller than the fog margin before the change. For example, the controller 30 performs control such that the charging potential is caused to be smaller than that before the change, thereby causing the fog margin to be smaller. At this time, since the controller 30 causes the fog margin to be smaller based on the slope, the controller 30 sets that the detection potential difference to be used between the next pair of sheets is also smaller than that before the change.

### Step S30

In a case where the slope is equal to or greater than the second slope threshold and equal to or less than the first slope threshold, the controller 30 determines that there is a small change in the fog state, does not perform the control for changing the fog margin when the print image is formed, and causes the fog margin before the change to remain.

As described above, the controller 30 obtains a graph of the detection potential difference and the sensor output value from a plurality of sensor output values obtained by causing the optical sensor S1 to perform measurement of a plurality of detection images, obtains a slope of the graph, and controls the fog margin when the print image is formed, according to the obtained slope.

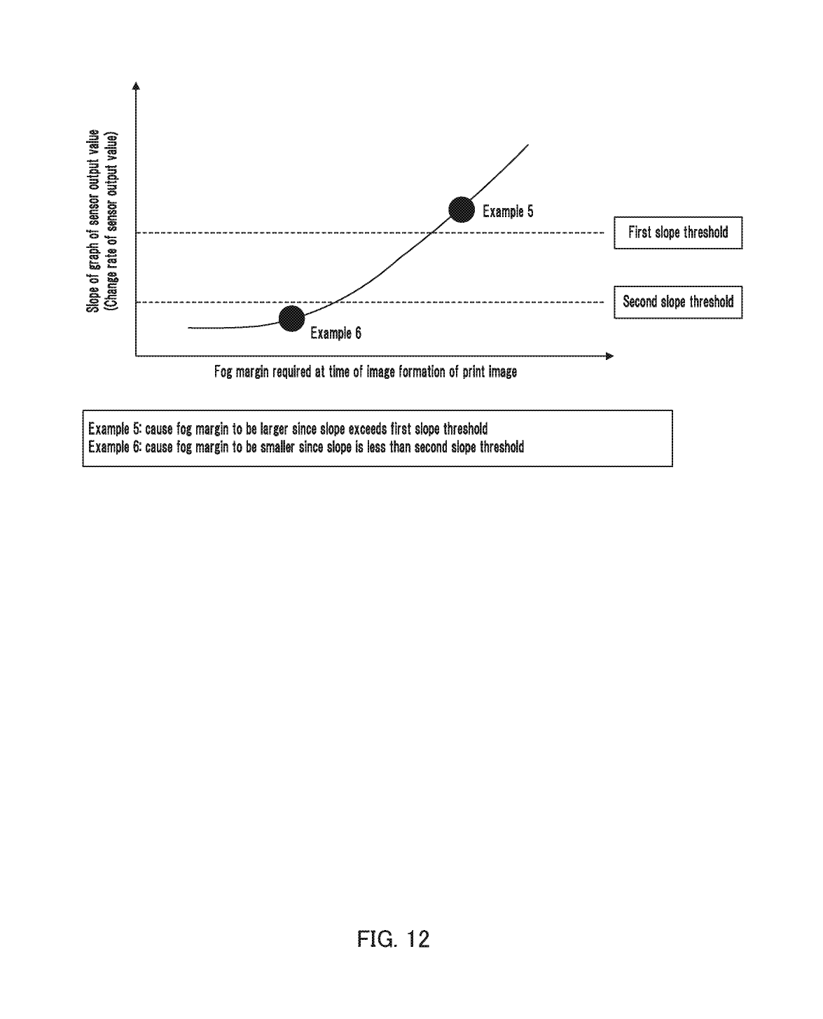

Here, steps S26 to S30 will be described with reference to FIG. 12. FIG. 12 is a graph provided for describing the relationship between a slope of a graph of the sensor output value and a fog margin required at the time of image formation of a print image. The graph illustrated in FIG. 12 can be obtained by performing the measurement described in FIG. 11 in a different fog state.

In FIG. 12, the slope illustrated in Example 5 exceeds the first slope threshold. That is, in the case of the slope illustrated in Example 5, the result in step S26 is “YES”. In this case, the controller 30 performs the processing described in step S28.

In addition, in FIG. 12, the slope illustrated in Example 6 is less than the second slope threshold. That is, in the case of the slope illustrated in Example 6, the result in step S27 is “YES”. In this case, the controller 30 performs the processing described in step S29.

Even in the present variation, in the case of changing the charging potential, it is desirable that the change in the charging potential be limited to 10 V to 30 V because when the charging potential is largely changed, a color tone may change and another image failure may occur.

In a case where the slope is equal to or greater than the second slope threshold and less than or equal to the first slope threshold, on the other hand, the result in step S26 is “NO” and the result in step S27 is “NO”. In this case, the controller 30 performs the processing described in step S30.

In this way, the controller 30 controls the fog margin such that the slope is equal to or larger than the second slope threshold and equal to or less than the first slope threshold.

The advantage of using a slope as in the present variation is that since a slope is obtained from measurement results of a plurality of detection images formed by changing the detection potential difference, variations in data can be suppressed and a more accurate result can be obtained. In this case, although depending on the apparatus configuration, the fog margin can be changed at about four points between one pair of sheets and, for example, the slope can be obtained from a plurality of detection images formed between one pair of sheets as illustrated on the left side of FIG. 10 and can be used for control. On the other hand, as illustrated on the right side of FIG. 10, a slope can also be obtained from a plurality of detection images formed over a plurality of pairs of sheets and used for control.

As described above, the fog margin setting method in the present variation may be executed between every pair of sheets or processing over a plurality of pairs of sheets may be continuously executed, but the execution interval can be appropriately changed, for example, such that the fog margin setting method is executed for every 100 sheets.

### Variation 2

Even in the present variation, the image forming apparatus 1 described above is used as the image forming apparatus. On the other hand, the present variation is different from the above-described embodiment and Variation 1 in the fog margin setting method. Briefly, in the present variation, the above-described embodiment and Variation 1 are combined, and finally a slope of a graph of the detection potential difference and the sensor output value is obtained and the fog margin at the time of the image formation of a print image is controlled based on the obtained slope.

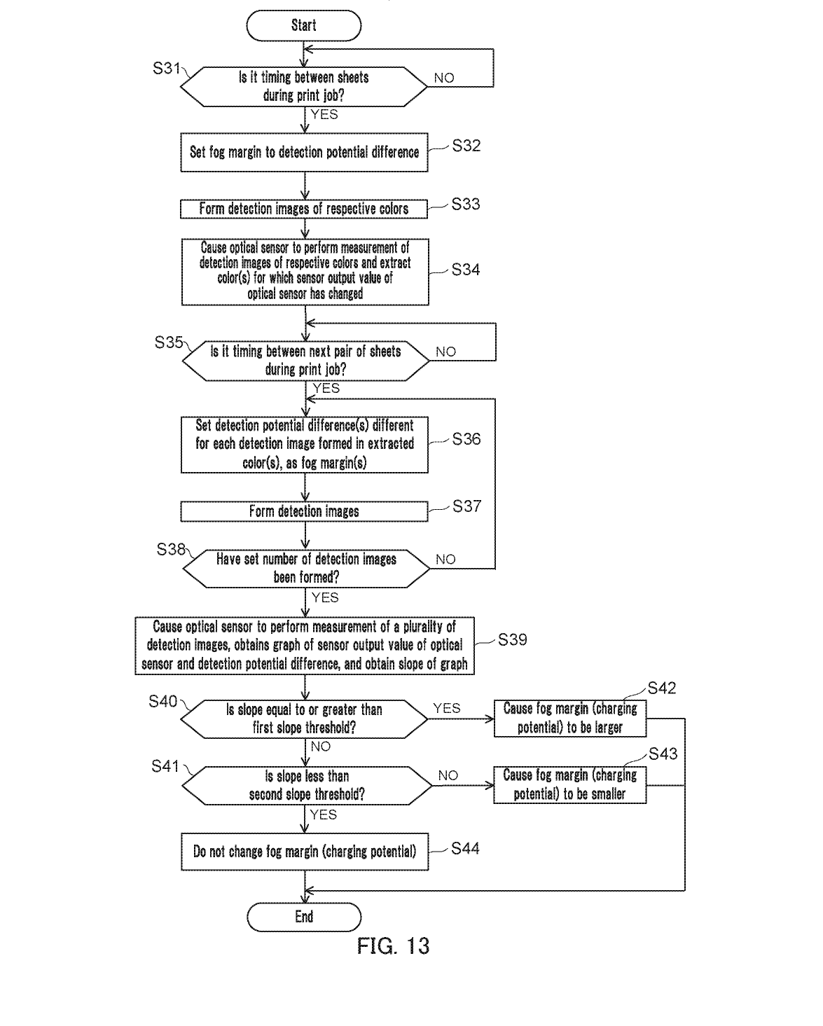

The fog margin setting method in the present variation will be described with reference to FIG. 13. FIG. 13 is a flowchart illustrating a variation (Variation 2) of the flowchart illustrated in FIG. 3.

### Step S31

Step S31 is substantially the same as step S11 described above, and the controller 30 determines whether it is a timing between sheets during a print job. In a case where it is a timing between sheets during a print job (YES), the controller 30 proceeds to step S32, whereas in a case where it is not a timing between sheets during a print job (NO), the controller 30 repeats step S31.

### Step S32

Step S32 is the same as step S12 described above, and when it is a timing between sheets during a print job, the controller 30 controls the image creators 2Y, 2M, 2C, 2K such that a fog margin is set to a detection potential difference.

### Step S33

The controller 30 controls the image creators 2Y, 2M, 2C, and 2K and the intermediate transferer 3 such that detection images of the respective colors are formed on the intermediate transfer belt 15. For example, the controller 30 performs control such that one detection image is formed for each of the Y, M, C, and K colors between sheets (see the left drawing in FIG. 4).

### Step S34

The controller 30 causes the optical sensor S1 to perform measurement of the detection images of the respective colors formed on the intermediate transfer belt 15, and extracts a color(s) for which the sensor output value of the optical sensor S1 has changed. The controller 30 may determine whether the sensor output value has changed, for example, by comparison with the first and second thresholds described with reference to FIGS. 3 and 7. That is, it is configured here such that the controller 30 determines the colors of the detection image to be formed between the next pair of sheets. Note that, although not illustrated in FIG. 13, in a case where the controller 30 determines that there is no color for which the sensor output value has changed, the controller 30 ends the processing without performing the subsequent processing.

### Step S35

The controller 30 determines whether it is the timing between the next pair of sheets (between the next pair of sheets after between one pair of sheets for which the processing in steps S32 to S34 has been performed) during a print job. In a case where it is the timing between the sheets during the print job (YES), the controller 30 proceeds to step S36, whereas in a case where it is not the timing between the sheets during the print job (NO), the controller 30 repeats step S35.

### Step S36

When it is the timing between the sheets during the print job, the controller 30 controls, among the image creators 2Y, 2M, 2C, and 2K, the image former corresponding to the extracted color(s) such that a detection potential difference(s) different for each detection image formed in the extracted color(s) is/are set as a fog margin(s).

### Step S37

The controller 30 controls, among the image creators 2Y, 2M, 2C, and 2K, the image former(s) corresponding to the extracted color(s) and the intermediate transferer 3 such that detection images are formed on the intermediate transfer belt 15.

### Step S38

Step S38 is substantially the same as step S24 described above, and the controller 30 determines whether a set number of detection images have been formed. In a case where the set number of detection images have been formed (YES), the controller 30 proceeds to step S39, whereas in a case where the set number of detection images have not been formed (NO), the controller 30 returns to step S36. The number of detection images to be formed is set according to, for example, the time between sheets, or the like. In addition, the controller 30 may cause a plurality of detection images to be formed between one pair of sheets or may cause a plurality of detection images to be formed between a plurality of pairs of sheets, and in the latter case, it is configured such that the controller 30 returns to step S35 in a case where the result in step S38 is “NO”.

### Steps S39 to S44

Steps S39 to S44 are substantially the same as steps S25 to S30 described above, and here, although a description is omitted, the controller 30 control the fog margin by controlling the image creators 2Y, 2M, 2C, 2K and the intermediate transferer 3 for the color(s) extracted in step S34. In a case where there is a plurality of colors extracted in step S34, the controller 30 performs the processing in steps S35 to S44 for each color to control the fog margins for the plurality of extracted colors.

As described above, the controller 30 first checks whether there is/are a change(s) in the sensor output values of the optical sensor S1 in the detection images for all colors. Then, for a color(s) for which there is/are a change(s) in the sensor output values, the controller 30 acquires the respective sensor output values of the optical sensor S1 from the detection images formed with a plurality of different detection potential differences, respectively, and controls the fog margin when the print image is formed, based on the plurality of acquired sensor output values. By performing such processing, it is possible to perform measurement with high detection accuracy for a color for which there is a change, and as a result, it is possible to accurately control the fog margin.

In the fog margin setting method of the present variation, the processing over a plurality of pairs of sheets may be continuously conducted, but the execution interval can be appropriately changed, for example, such that the fog margin setting method is executed for every 100 sheets.

### Variation 3

Although the controller 30 does not change a setting range of the detection potential difference in the above-described embodiment and Variations 1 and 2, the setting range of the detection potential difference may be changed, for example, according to the above-described sensor output value of the optical sensor S1 or the above-described slope obtained from sensor output values.

The setting range of the detection potential difference can be changed in any of the above-described embodiment and Variations 1 and 2. Here, a case where the setting range of the detection potential difference is changed according to the sensor output value of the optical sensor S1 in the above-described embodiment will be described as an example. In this case, the setting range of the detection potential difference set in step S12 of the flowchart illustrated in FIG. 3 is changed.

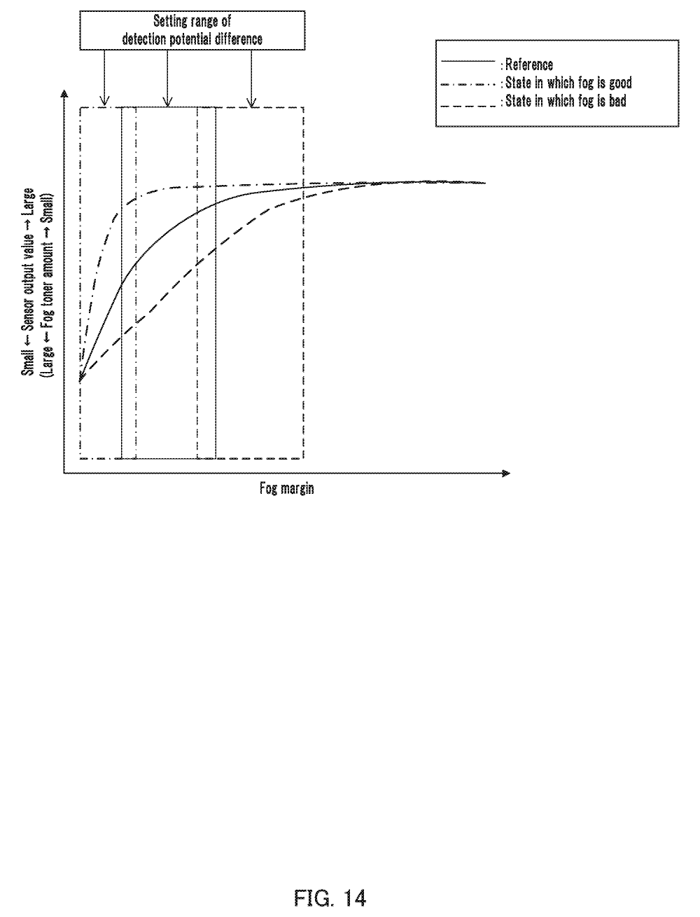

FIG. 14 is a diagram provided for describing setting ranges of detection potential differences in different fog states.

As illustrated in FIG. 14, when the fog state changes, the graph of the sensor output value of the optical sensor S1 with respect to the fog margin also changes, where there are a region, in which the change is large, and a region, in which the change is small, and the ranges of these regions also change. In each fog state, a sensor output value can be acquired more accurately, that is, a fog toner amount can be acquired more accurately by forming a detection image by using the detection potential difference in the region, in which the change is large, and causing the optical sensor S1 to perform measurement of the formed detection image. For this reason, the controller 30 changes a range, for which the detection potential difference is set, based on the tendency of a change in the sensor output value of the optical sensor S1.

For example, in a reference fog state, the controller 30 sets a setting range surrounded by a solid line as a range for which the detection potential difference is set. Then, in a case where there is a state in which the fog becomes poor, the controller 30 changes the setting range from the setting range surrounded by the solid line to a setting range surrounded by a broken line, in a direction in which the fog margin becomes larger. In addition, in a case where the fog becomes good, the controller 30 changes the setting range from the setting range surrounded by the solid line to a setting range surrounded by a one-dot-chain line, in a direction in which the fog margin becomes smaller.

In this way, by changing the setting range, for which the detection potential difference is set, according to the fog state, the controller 30 causes a detection image to be formed using the detection potential difference in the region in which the change is large. As a result, the controller 30 can acquire a sensor output value more accurately, that is, can acquire a fog toner amount more accurately as described above.

Note that, in a case where the detection potential difference is changed, the controller 30 also changes the above-described first to fourth thresholds and the above-described first to second slope thresholds according to the changed detection potential difference. The first to fourth thresholds and the first and second slope thresholds can be uniquely obtained from a plurality of detection images formed with a plurality of different detection potential differences, respectively, and sensor output values obtained by performing measurement of the detection images with the optical sensor S1. The controller 30 may obtain in advance the first to fourth thresholds and the first and second thresholds corresponding to a plurality of different detection potential differences, respectively, and store the obtained first to fourth thresholds and the obtained first and second thresholds in the storage of the controller 30.

Any of the embodiment described above is only illustration of an exemplary embodiment for implementing the present invention, and the technical scope of the present invention shall not be construed limitedly thereby. That is, the present invention can be implemented in various forms without departing from the gist or the main features thereof.

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
at least one hardware processor that controls an image former such that the image former forms a detection image with toner by setting a fog margin to a detection potential difference at a timing between a plurality of sheets during a print job, the fog margin being a potential difference between a charging potential of a photoconductor and a developing potential of a developing apparatus; and
a detector that detects a toner amount or a value related to the toner amount in the formed detection image, wherein
the at least one hardware processor sets, based on the detected toner amount or the detected value, the fog margin when a print image is formed.

2. The image forming apparatus according to claim 1, wherein
the at least one hardware processor changes the charging potential to set the fog margin when the print image is formed.

3. The image forming apparatus according to claim 1, wherein
the at least one hardware processor changes a range for which the detection potential difference is set, based on a tendency of a change in a plurality of the detected toner amounts or a plurality of the detected values in a plurality of the detection images, the plurality of detection images having been formed with a plurality of the detection potential differences, respectively, the plurality of detection potential differences being different from each other.

4. The image forming apparatus according to claim 1, wherein
the at least one hardware processor changes a number of colors of a plurality of the detection images according to whether image quality or detection accuracy is prioritized, the plurality of detection images being formed between one pair of sheets among the plurality of sheets.

5. The image forming apparatus according to claim 1, wherein
in a case where the detected toner amount does not exceed a first threshold, the at least one hardware processor causes the fog margin, when the print image is formed, to be smaller than the fog margin before a change, the first threshold being a lower limit value of the toner amount.

6. The image forming apparatus according to claim 5, wherein
in a case where the detected toner amount exceeds a second threshold, the at least one hardware processor causes the fog margin, when the print image is formed, to be larger than the fog margin before the change, the second threshold being an upper limit value of the toner amount.

7. The image forming apparatus according to claim 6, wherein
in a case where the detected toner amount exceeds a fourth threshold larger than the second threshold or in a case where the detected toner amount does not exceed a third threshold smaller than the first threshold, the at least one hardware processor forms, at a timing other than the timing between the plurality of sheets, a plurality of the detection images with a plurality of the detection potential differences, respectively, and sets the fog margin when the print image is formed, based on a plurality of the toner amounts in the plurality of detection images, the plurality of detection potential differences being different from each other, each of the plurality of toner amounts having been detected by the detector.

8. The image forming apparatus according to claim 1, wherein
the at least one hardware processor forms a plurality of the detection images in different colors, respectively, and determines, based on a plurality of the toner amounts in the plurality of detection images, a color of the detection image that is formed between a next pair of sheets among the plurality of sheets, each of the plurality of toner amounts having been detected by the detector.

9. The image forming apparatus according to claim 1, wherein
the at least one hardware processor forms, between one pair of sheets or a plurality of pairs of sheets among the plurality of sheets, a plurality of the detection images with a plurality of the detection potential differences, respectively, and sets, based on a change rate of a plurality of the toner amounts in the plurality of detection images with respect to the plurality of detection potential differences, the fog margin when the print image is formed, each of the plurality of toner amounts having been detected by the detector, the plurality of detection potential differences being different from each other.

10. The image forming apparatus according to claim 1, wherein
the at least one hardware processor sets, based on the detected toner amount or the detected value, the detection potential difference to be used between a next pair of sheets among the plurality of sheets.

11. A fog margin setting method, comprising:
forming, by an image former, a detection image with toner by setting a fog margin to a detection potential difference at a timing between a plurality of sheets during a print job, the fog margin being a potential difference between a charging potential of a photoconductor and a developing potential of a developing apparatus;
detecting, by a detector, a toner amount or a value related to the toner amount in the formed detection image; and
setting, based on the detected toner amount or the detected value, the fog margin when a print image is formed.

12. A non-transitory computer-readable recording medium storing a fog margin setting program that causes a computer to execute:
forming, by an image former, a detection image with toner by setting a fog margin to a detection potential difference at a timing between a plurality of sheets during a print job, the fog margin being a potential difference between a charging potential of a photoconductor and a developing potential of a developing apparatus;
detecting, by a detector, a toner amount or a value related to the toner amount in the formed detection image; and
setting, based on the detected toner amount or the detected value, the fog margin when a print image is formed.
